(19) United States
(12) Patent Application Publication
(10) Pub. No.: US 2013/0021335 A1
(43) Pub. Date: Jan. 24, 2013

(54) IMAGE PROCESSING DEVICE, IMAGE PROCESSING METHOD, AND MEDICAL IMAGE DIAGNOSTIC DEVICE

(71) Applicants: Kazumasa Arakita, Nasushiobara-shi (JP); Yasuhiro Noshi, Otawara-shi (JP); Tatsuo Maeda, Nasushiobara-shi (JP); Go Mukumoto, Utsunomiya-shi (JP); Takahiro Yoda, Nasushiobara-shi (JP); Yoshiaki Yaoi, Nasushiobara-shi (JP); Tomonori Ozaki, Otawara-shi (JP)

(72) Inventors: Kazumasa Arakita, Nasushiobara-shi (JP); Yasuhiro Noshi, Otawara-shi (JP); Tatsuo Maeda, Nasushiobara-shi (JP); Go Mukumoto, Utsunomiya-shi (JP); Takahiro Yoda, Nasushiobara-shi (JP); Yoshiaki Yaoi, Nasushiobara-shi (JP); Tomonori Ozaki, Otawara-shi (JP)

(73) Assignees: Toshiba Medical Systems Corporation, Otawara-shi (JP); Kabushiki Kaisha Toshiba, Tokyo (JP)

(21) Appl. No.: 13/552,002

(22) Filed: Jul. 18, 2012

(30) Foreign Application Priority Data
Jul. 19, 2011 (JP) 2011-158285

(51) Int. Cl. G06T 15/00

(52) U.S. Cl. 345/419

(57) ABSTRACT

In an image processing system according to an embodiment, an image processing device in the embodiment includes a receiving unit, a flat image generator, and an output unit. The receiving unit receives setting of a region of interest on parallax images of a subject that are displayed stereoscopically. The flat image generator generates a flat image of a cut surface of the subject that is generated by cutting the subject along a plane corresponding to the region of interest received by the receiving unit based on volume data of the subject stored in a predetermined storage device. The output unit outputs the flat image generated by the flat image generator.

### CROSS-REFERENCE TO RELATED APPLICATIONS

This application is based upon and claims the benefit of priority from Japanese Patent Application No. 2011-158285, filed on Jul. 19, 2011; the entire contents of which are incorporated herein by reference.

### FIELD

Embodiments described herein relate generally to an image processing device, an image processing method, and a medical image diagnostic device.

### BACKGROUND

Conventionally known is a technique of displaying two parallax images shot from two viewpoints on a monitor so as to display a stereoscopic image for a user using a dedicated device such as stereoscopic glasses. Furthermore, in recent years, also known is a technique of displaying multi-parallax images (for example, nine parallax images) shot from a plurality of viewpoints on a monitor using a light beam controller such as a lenticular lens so as to display a stereoscopic image for a user with naked eyes.

As medical image diagnostic devices such as X-ray computed tomography (CT) devices, magnetic resonance imaging (MRI) devices, and ultrasonography devices, there are devices that can generate three-dimensional medical images (hereinafter, volume data). Such a medical image diagnostic device generates a flat image for display by executing various pieces of image processing on volume data and displays the generated flat image on a general-purpose monitor. For example, the medical image diagnostic device executes volume rendering processing on volume data so as to generate a flat image of an arbitrary cross section onto which three-dimensional information for a subject has been reflected, and displays the generated flat image on the general-purpose monitor.

### BRIEF DESCRIPTION OF THE DRAWINGS

FIG. 1 is a diagram for explaining a configuration example of an image processing system according to a first embodiment;

FIGS. 2A and 2B are views for explaining an example of a stereoscopic display monitor on which stereoscopic display is performed with two parallax images;

FIG. 3 is a view for explaining an example of a stereoscopic display monitor on which stereoscopic display is performed with nine parallax images;

FIG. 4 is a diagram for explaining a configuration example of a workstation in the first embodiment;

FIG. 5 is a diagram for explaining a configuration example of a rendering processor as illustrated in FIG. 4;

FIG. 6 is a view for explaining an example of volume rendering processing in the first embodiment;

FIG. 7 is a diagram for explaining details of a controller in the first embodiment;

FIG. 8 is a view illustrating examples of flat images that are generated by a flat image generator in the first embodiment;

FIG. 9 is a view illustrating an example of a stereoscopic image that is displayed by displaying parallax images that are generated by a parallax image generator in the first embodiment;

FIG. 10 is a view illustrating examples of a stereoscopic image and flat images that are displayed on a terminal device as a result of output from an output unit in the first embodiment;

FIG. 11 is a view illustrating other examples of a stereoscopic image and flat images that are displayed on the terminal device as a result of output from the output unit in the first embodiment;

FIG. 12 is a view illustrating an example when a flat image is displayed at a position of a cursor in the first embodiment;

FIG. 13 is a view illustrating an example of a method of controlling directivity of light that is given by a lenticular lens layer in a decreasing direction;

FIG. 14 is a flowchart illustrating an example of a flow of processing by an image processing device in the first embodiment;

FIGS. 15A and 15B are views illustrating an example of effects in the first embodiment;

FIG. 16 is a diagram illustrating an example of a configuration of a controller that further includes a subject flat image generator and a storage processor;

FIG. 17 is a view illustrating an example in which a stereoscopic image and a subject flat image are displayed together;

FIG. 18 is a view illustrating an example of a stereoscopic image; and

FIG. 19 is a view for explaining an example in which directivity of light that is given by the lenticular lens layer is increased or decreased in the first embodiment.

### DETAILED DESCRIPTION

An image processing device according to an embodiment includes a receiving unit, a flat image generator, and an output unit. The receiving unit receives setting of a region of interest on parallax images of a subject that are displayed stereoscopically. The flat image generator generates a flat image of a cut surface of the subject that is generated by cutting the subject along a plane corresponding to the region of interest received by the receiving unit based on volume data of the subject stored in a predetermined storage device. The output unit outputs the flat image generated by the flat image generator.

Hereinafter, embodiments of the image processing device, an image processing method and a medical image diagnostic device are described in detail with reference to accompanying drawings. It is to be noted that an image processing system including a workstation having a function as the image processing device is described as an embodiment, hereinafter.

### First Embodiment

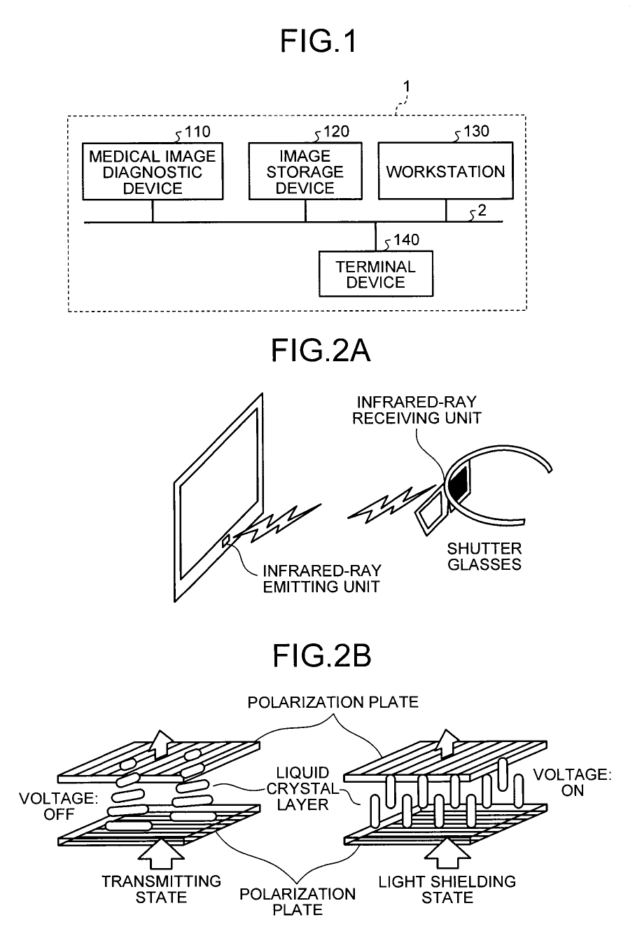

At first, a configuration example of an image processing system that has an image processing device according to a first embodiment is described. FIG. 1 is a diagram for explaining a configuration example of the image processing system in the first embodiment.

As illustrated in FIG. 1, an image processing system 1 in the first embodiment includes a medical image diagnostic device 110, an image storage device 120, a workstation 130, and a terminal device 140. The devices as illustrated in FIG. 1 are made into states of being communicable with one another directly or indirectly with an in-hospital local area network (LAN) 2 installed in a hospital, for example. For example, when a picture archiving and communication system (PACS) is introduced in the image processing system 1, the devices transmit and receive a medical image and the like to and from one another in accordance with a standard of digital imaging and communications in medicine (DICOM).

The image processing system 1 generates parallax images for displaying a stereoscopic image based on volume data generated by the medical image diagnostic device 110 and displays the generated parallax images on a monitor that can display a stereoscopic image. This provides the stereoscopic image to a physician or a laboratory technician who works in a hospital.

A “stereoscopic image” is displayed for a user by displaying a plurality of parallax images that have been shot from a plurality of viewpoints and of which parallax angles are different from one another. In other words, the “parallax images” are images that have been shot from a plurality of viewpoints and of which parallax angles are different from one another. Furthermore, the “parallax images” are images for displaying a stereoscopic image for a user. The parallax images for displaying a stereoscopic image are generated by performing volume rendering processing on volume data, for example.

Furthermore, the “parallax images” are individual images constituting a “stereoscopic view image”. That is to say, the “stereoscopic view image” is constituted by a plurality of “parallax images” of which “parallax angles” are different from one another. In addition, the “number of parallaxes” is the number of “parallax images” required for being viewed stereoscopically on a stereoscopic display monitor. The “parallax angle” is an angle that is set for generating the “stereoscopic view image” and is defined by an interval between positions of viewpoints and a position of volume data. A “nine-parallax image” as will be described below indicates a “stereoscopic view image” that is constituted by nine “parallax images”. Furthermore, a “two-parallax image” as will be described below indicates a “stereoscopic view image” that is constituted by two “parallax images”. A “stereoscopic image” is displayed for a user by displaying a stereoscopic view image, that is, displaying a plurality of parallax images.

As will be described in detail below, in the first embodiment, the workstation 130 performs various types of image processing on volume data so as to generate parallax images for displaying a stereoscopic image. Each of the workstation 130 and the terminal device 140 has a monitor that can display a stereoscopic image. Each of the workstation 130 and the terminal device 140 displays parallax images generated by the workstation 130 on the monitor so as to display a stereoscopic image for a user. The image storage device 120 stores therein volume data generated by the medical image diagnostic device 110 and parallax images generated by the workstation 130. For example, the workstation 130 or the terminal device 140 acquires volume data and parallax images from the image storage device 120. Furthermore, the workstation 130 or the terminal device 140 executes arbitrary image processing on the acquired volume data and parallax images and displays the parallax images on the monitor.

The medical image diagnostic device 110 is an X-ray diagnostic device, an X-ray computed tomography (CT) device, a magnetic resonance imaging (MRI) device, an ultrasonography device, a single photon emission computed tomography (SPECT) device, a positron emission computed tomography (PET) device, a SPECT-CT device in which the SPECT device and the X-ray CT device are integrated with each other, a PET-CT device in which the PET device and the X-ray CT device are integrated with each other, a device group of these devices, or the like. The medical image diagnostic device 110 generates volume data.

To be more specific, the medical image diagnostic device 110 in the first embodiment shoots a subject so as to generate volume data. For example, the medical image diagnostic device 110 shoots a subject to collect projection data and data of MR signals and the like. Then, the medical image diagnostic device 110 reconstructs medical images of a plurality of axial surfaces along a body axis direction of the subject based on the collected data so as to generate volume data. For example, description is made using a case where the medical image diagnostic device 110 reconstructs medical images of 500 axial surfaces. In this case, a medical image group of 500 axial surfaces that has been reconstructed by the medical image diagnostic device 110 corresponds to volume data. It is to be noted that projection data and MR signals and the like themselves of a subject that have been shot by the medical image diagnostic device 110 may be used as volume data.

Furthermore, the medical image diagnostic device 110 transmits volume data to the image storage device 120. It is to be noted that when the medical image diagnostic device 110 transmits the volume data to the image storage device 120, the medical image diagnostic device 110 transmits a patient ID for identifying a patient, a test ID for identifying a test, a device ID for identifying the medical image diagnostic device 110, a series ID for identifying one shooting by the medical image diagnostic device 110, and the like as accompanying information.

The image storage device 120 is a database that stores therein medical images. To be more specific, the image storage device 120 receives volume data from the medical image diagnostic device 110 and stores the received volume data in a predetermined storage unit. Furthermore, the image storage device 120 receives parallax images generated from volume data by the workstation 130 and stores the received parallax images in a predetermined storage unit. It is to be noted that the image storage device 120 and the workstation 130 may be integrated with each other so as to form one device.

In the first embodiment, the volume data and the parallax images stored in the image storage device 120 are stored so as to correspond to the patient ID, the test ID, the device ID, the series ID, and the like. Therefore, the workstation 130 or the terminal device 140 acquires necessary volume data and parallax images from the image storage device 120 by searching them using the patient ID, the test ID, the device ID, the series ID, and the like. It is to be noted that the image storage device 120 and the workstation 130 may be integrated with each other so as to form one device.

The workstation 130 is an image processing device that performs image processing on a medical image. To be more specific, the workstation 130 acquires volume data from the image storage device 120. Then, the workstation 130 performs various pieces of rendering processing on the acquired volume data so as to generate parallax images for displaying a stereoscopic image. For example, when the workstation 130 displays a two-parallax stereoscopic image for a user, the workstation 130 generates two parallax images of which parallax angles are different from each other. Alternatively, when the workstation 130 displays a nine-parallax stereoscopic image for a user, the workstation 130 generates nine parallax images of which parallax angles are different from one another, for example.

Furthermore, the workstation 130 has a monitor (also referred to as stereoscopic display monitor or stereoscopic image display device) that can display a stereoscopic image as a display unit. The workstation 130 generates parallax images and displays the generated parallax images on the stereoscopic display monitor. With this, the workstation 130 displays a stereoscopic image for a user. As a result, the user of the workstation 130 can perform an operation for generating parallax images while checking the stereoscopic image displayed on the stereoscopic display monitor.

Furthermore, the workstation 130 transmits the generated parallax images to the image storage device 120 and the terminal device 140. It is to be noted that when the workstation 130 transmits the parallax images to the image storage device 120 and the terminal device 140, the workstation 130 transmits the patient ID, the test ID, the device ID, the series ID, and the like together with the parallax images as accompanying information, for example. In this case, the workstation 130 may transmit accompanying information indicating the number of parallax images and a resolution in consideration of a fact that resolutions of all the monitors are not the same. The resolution corresponds to “466 pixels×350 pixels”, for example.

The workstation 130 in the first embodiment receives setting of a region of interest on a stereoscopic image of a subject that is displayed on the terminal device 140. Then, the workstation 130 generates a flat image of a cut surface of the subject that is generated by cutting the subject along a plane corresponding to the received region of interest based on volume data of the subject stored in the image storage device 120. Thereafter, the workstation 130 outputs the generated flat image. As a result, a positional relationship on the stereoscopic image can be grasped easily. Note that it is difficult to grasp a positional relationship of an image that is desired to be focused when viewing stereoscopically only in some cases. In consideration of the fact, a flat image is displayed in conjunction with a stereoscopic image that is displayed on a 3D monitor. This makes it possible to grasp a positional relationship on the stereoscopic image easily. As a result, a positional relationship between the stereoscopic image on the 3D monitor and the image that is desired to be focused can be grasped easily, for example.

Returning back to description with reference to FIG. 1, the terminal device 140 is a terminal for making a physician or a laboratory technician who works in a hospital browse a medical image. To be more specific, the terminal device 140 has a stereoscopic display monitor as a display unit. The terminal device 140 acquires parallax images from the image storage device 120 and displays the acquired parallax images on the stereoscopic display monitor so as to display a stereoscopic image for a user. For example, if the terminal device 140 receives parallax images from the workstation 130, the terminal device 140 displays the received parallax images on the stereoscopic display monitor. With this, the terminal device 140 displays a stereoscopic image for a user. As a result, a physician or a laboratory technician as the user can browse a medical image that can be viewed stereoscopically. The terminal device 140 corresponds to a general-purpose personal computer (PC), a tablet terminal, or a mobile phone each having a stereoscopic display monitor, for example. Alternatively, the terminal device 140 corresponds to an arbitrary information processing terminal connected to a stereoscopic display monitor as an external device, for example.

The stereoscopic display monitor that each of the workstation 130 and the terminal device 140 has is described. As the stereoscopic display monitor, there is a stereoscopic display monitor that displays a two-parallax stereoscopic image (binocular parallax image) for a user wearing a dedicated device such as stereoscopic glasses by displaying two parallax images, for example.

FIGS. 2A and 2B are views for explaining an example of a stereoscopic display monitor that performs stereoscopic display with two-parallax images. In the example as illustrated in FIGS. 2A and 2B, a stereoscopic display monitor that performs stereoscopic display with a shutter method is illustrated as an example. In the example as illustrated in FIGS. 2A and 2B, a user who observes the monitor wears shutter glasses as stereoscopic glasses. In the example as illustrated in FIGS. 2A and 2B, the stereoscopic display monitor outputs two parallax images alternately. For example, the stereoscopic display monitor as illustrated in FIG. 2A outputs a parallax image for a left eye and a parallax image for a right eye alternately at 120 Hz. Furthermore, as illustrated in FIG. 2A, an infrared-ray emitting unit is installed on the stereoscopic display monitor and the infrared-ray emitting unit controls emission of infrared rays at timings when the parallax images are switched.

Furthermore, as illustrated in FIG. 2A, an infrared-ray receiving unit of the shutter glasses receives infrared rays emitted from the infrared-ray emitting unit. A shutter is attached to each of right and left frames of the shutter glasses. The shutter glasses switch a transmitting state and a light shielding state of each of right and left shutters alternately at timings when the infrared-ray receiving unit receives infrared rays.

Then, switching processing between the transmitting state and the light shielding state on each shutter of the shutter glasses is described. As illustrated in FIG. 2B, each shutter has a polarization plate at an incident side and a polarization plate at an output side. Furthermore, each shutter has a liquid crystal layer between the polarization plate at the incident side and the polarization plate at the output side. As illustrated in FIG. 2B, the polarization plate at the incident side and the polarization plate at the output side are orthogonal to each other. As illustrated in FIG. 2B, in an “OFF” state where voltage is not applied, light passing through the polarization plate at the incident side rotates by 90 degrees with an action by the liquid crystal layer and transmits through the polarization plate at the output side. That is to say, the shutter to which voltage is not applied is in the transmitting state.

On the other hand, as illustrated in FIG. 2B, in an “ON” state where voltage is applied, a polarization rotation action by liquid crystal molecules of the liquid crystal layer is not exhibited. Therefore, in the “ON” state, light passing through the polarization plate at the incident side is shielded by the polarization plate at the output side. That is to say, the shutter to which voltage is applied is in the light shielding state.

In consideration of that, the infrared-ray emitting unit of the stereoscopic display monitor emits infrared rays for a period during which an image for the left eye is displayed on the monitor, for example. Furthermore, the infrared-ray receiving unit of the shutter glasses does not apply voltage to the shutter for the left eye and applies voltage to the shutter for the right eye for a period during which the infrared-ray receiving unit receives the infrared rays. With this, as illustrated in FIG. 2A, the shutter for the right eye is made into the light shielding state and the shutter for the left eye is made into the transmitting state. As a result, the image for the left eye is incident on only the left eye of the user. On the other hand, the infrared-ray emitting unit of the stereoscopic display monitor stops emission of infrared rays for a period during which an image for the right eye is displayed on the monitor, for example. Then, the infrared-ray receiving unit of the shutter glasses does not apply voltage to the shutter for the right eye and applies voltage to the shutter for the left eye for a period during which the infrared-ray receiving unit does not receive infrared rays. With this, the shutter for the left eye is made into the light shielding state and the shutter for the right eye is made into the transmitting state. As a result, the image for the right eye is incident on only the right eye of the user. In this manner, the stereoscopic display monitor as illustrated in FIGS. 2A and 2B switches an image that is displayed on the monitor and states of the shutters in conjunction with each other so as to display a stereoscopic image for the user.

In addition, as the stereoscopic display monitor, there is also a stereoscopic display monitor that displays a nine-parallax stereoscopic image for a user with naked eyes using a light beam controller such as a lenticular lens, for example. In this case, the stereoscopic display monitor makes it possible to perform stereoscopic view with binocular parallax. In addition, the stereoscopic display monitor can display a stereoscopic image having motion parallax with which a video image observed by a user changes in accordance with movement of a viewpoint of the user.

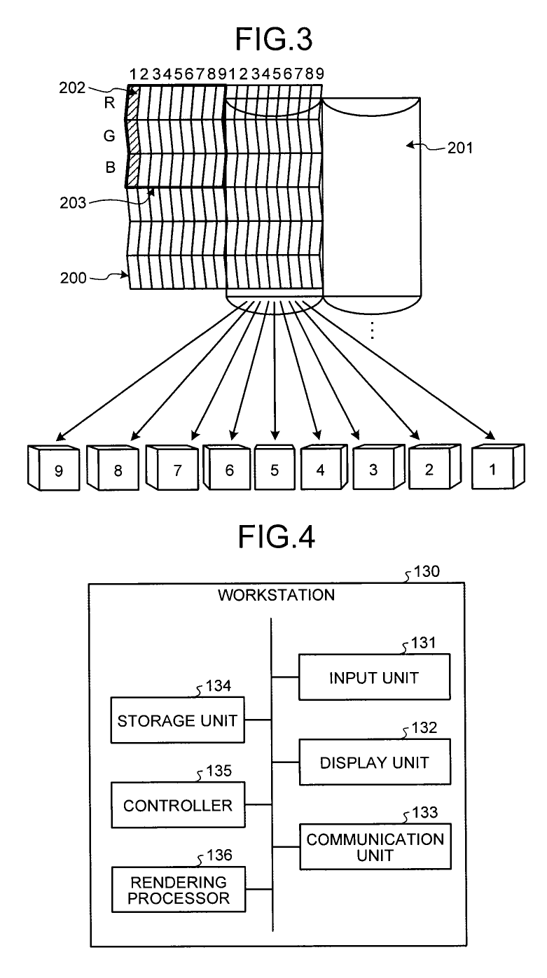

FIG. 3 is a view for explaining an example of a stereoscopic display monitor that performs stereoscopic display with nine parallax images. On the stereoscopic display monitor as illustrated in FIG. 3, a light beam controller is arranged on a front surface of a planar display surface 200 such as a liquid crystal panel. For example, on the stereoscopic display monitor as illustrated in FIG. 3, a perpendicular lenticular sheet 201 of which optical opening extends in the perpendicular direction is attached to the front surface of the display surface 200, as the light beam controller. In the example as illustrated in FIG. 3, the perpendicular lenticular sheet 201 is attached such that convex portions thereof are at a front surface side. However, the perpendicular lenticular sheet 201 may be attached such that the convex portions thereof are opposed to the display surface 200.

In the example as illustrated in FIG. 3, pixels 202 are arranged in a matrix form on the display surface 200. Each pixel 202 has an aspect ratio of 3:1. To be more specific, three sub pixels of red (R), green (G), and blue (B) are arranged in a longitudinal direction on each pixel 202. In the example as illustrated in FIG. 3, on the stereoscopic display monitor, nine parallax images of which parallax angles are different from one another are arranged in a predetermined format (for example, grid form), and then, are output to the display surface 200. That is to say, on the stereoscopic display monitor as illustrated in FIG. 3, each of nine pixels that are located at the same position on the nine parallax images of which parallax angles are different from one another displays an intermediate image assigned to each of the pixels 202 of nine rows. The pixels 202 of nine rows correspond to a unit pixel group 203 that displays nine images of which parallax angles are different from one another at the same time. In the example as illustrated in FIG. 3, the intermediate images are arranged in the grid form. However, the intermediate images are not limited thereto and may be arranged in an arbitrary form.

The nine parallax images that have been output at the same time as the unit pixel group 203 and of which parallax angles are different from one another on the display surface 200 are emitted as parallel light by a light emitting diode (LED) backlight, for example, and is further emitted in multiple directions by the perpendicular lenticular sheet 201. If light of each pixel of the nine parallax images is emitted in the multiple directions, light incident on each of the right eye and the left eye of a user changes in conjunction with a position (viewpoint position) of the user. That is to say, the parallax images that are incident on the right eye and the parallax images that are incident on the left eye are parallax images of which parallax angles are different from one another depending on angles at which the user views. As a result, the user can recognize a stereoscopic image visually in which a shooting target is viewed at different view angles at each of nine positions as illustrated in FIG. 3, for example. For example, the user can recognize the stereoscopic image visually stereoscopically in a state of being opposed to the shooting target rightly at a position of “5” in FIG. 3. In addition, the user can recognize the stereoscopic image visually stereoscopically in a state where a direction of the shooting target is changed at each of positions other than “5” in FIG. 3. The example as illustrated in FIG. 3 is an example merely and the embodiment is not limited to the example. For example, in the example as illustrated in FIG. 3, a combination of the liquid crystal with a horizontal-stripe pattern (RRR . . . , GGG . . . , BBB . . . ) and vertical lenses is used. However, the embodiment is not limited thereto. For example, a combination of liquid crystal with a vertical-stripe pattern (RGBRGB . . . ) and oblique lenses may be used.

Hereinbefore, a configuration example of the image processing system 1 in the first embodiment has been described simply. Applications of the above-described image processing system 1 are not limited to a case where the PACS is introduced. For example, when an electronic chart system for managing electronic charts attached with medical images is introduced, the image processing system 1 may be also applied in the same manner. In this case, the image storage device 120 is a database that stores therein the electronic charts. Furthermore, for example, when a hospital information system (HIS) or a radiology information system (RIS) is introduced, the image processing system 1 may be also applied in the same manner. The image processing system 1 is not limited the above-described configuration example. Functions and divisions that the devices have may be changed appropriately depending on operation modes.

Next, a configuration example of the workstation 130 in the first embodiment is described with reference to FIG. 4. FIG. 4 is a diagram for explaining a configuration example of the workstation in the first embodiment.

The workstation 130 is a high-performance computer suitable to image processing and the like. In the example as illustrated in FIG. 4, the workstation 130 includes an input unit 131, a display unit 132, a communication unit 133, a storage unit 134, a controller 135, and a rendering processor 136. Hereinafter, description is made using a case where the workstation 130 is a high-performance computer suitable to image processing and the like. However, the workstation 130 is not limited thereto. The workstation 130 may be an arbitrary information processing device. For example, the workstation 130 may be an arbitrary personal computer.

The input unit 131 is a mouse, a keyboard, a trackball, and the like and receives input of various types of operations to the workstation 130 from a user. To be more specific, the input unit 131 receives input of information for acquiring volume data as a target of rendering processing from the image storage device 120. For example, the input unit 131 receives input of a patient ID, a test ID, a device ID, a series ID, and the like. Furthermore, the input unit 131 receives input of conditions (hereinafter, rendering conditions) relating to the rendering processing.

The display unit 132 is a liquid crystal panel or the like as a stereoscopic display monitor and displays various types of information. To be more specific, the display unit 132 in the first embodiment displays a graphical user interface (GUI) for receiving various types of operations from a user, a stereoscopic image, and the like. The communication unit 133 is a network interface card (NIC) or the like and communicates with other devices. Furthermore, the communication unit 133 receives the rendering conditions input to the terminal device 140 by a user from the terminal device 140, for example.

The storage unit 134 is a hard disk, a semiconductor memory element, or the like, and stores various types of information. To be more specific, the storage unit 134 stores therein volume data acquired from the image storage device 120 through the communication unit 133. Furthermore, the storage unit 134 stores therein volume data on which the rendering processing is being performed, and parallax images and the like on which the rendering processing has been performed, and accompanying information (the number of parallaxes, resolution, and the like) thereof.

The controller 135 is an electronic circuit such as a central processing unit (CPU), a micro processing unit (MPU), and a graphics processing unit (GPU), or an integrated circuit such as an application specific integrated circuit (ASIC) and a field programmable gate array (FPGA). The controller 135 controls the entire workstation 130.

For example, the controller 135 controls display of a GUI and display of a stereoscopic image on the display unit 132. Furthermore, the controller 135 controls transmission and reception of volume data and parallax images that are performed between the workstation 130 and the image storage device 120 through the communication unit 133, for example. In addition, the controller 135 controls rendering processing by the rendering processor 136, for example. Moreover, the controller 135 controls reading of volume data from the storage unit 134 and storage of parallax images in the storage unit 134, for example.

The controller 135 of the workstation 130 controls the rendering processing by the rendering processor 136 and operates in cooperation with the rendering processor 136 so as to execute measuring processing. Details of the controller 135 are described after the rendering processor 136 is described.

The rendering processor 136 performs various pieces of rendering processing on volume data acquired from the image storage device 120 under control by the controller 135 so as to generate parallax images. To be more specific, the rendering processor 136 reads volume data from the storage unit 134 and performs preprocessing on the read volume data. Then, the rendering processor 136 performs volume rendering processing on the volume data on which the preprocessing has been performed so as to generate parallax images for displaying a stereoscopic image. Thereafter, the rendering processor 136 stores the generated parallax images in the storage unit 134.

Furthermore, the rendering processor 136 may generate overlay images on which various types of information (scale, therein name, test item, and the like) are drawn out and superimpose the generated overlay images on the parallax images. In this case, the rendering processor 136 stores the parallax images on which the overlay images have been superimposed in the storage unit 134.

It is to be noted that the rendering processing indicates the entire image processing to be performed on volume data and the volume rendering processing indicates processing of generating a medical image onto which three-dimensional information of a subject has been reflected in the rendering processing. The medical image that is generated by the rendering processing corresponds to parallax images, for example.

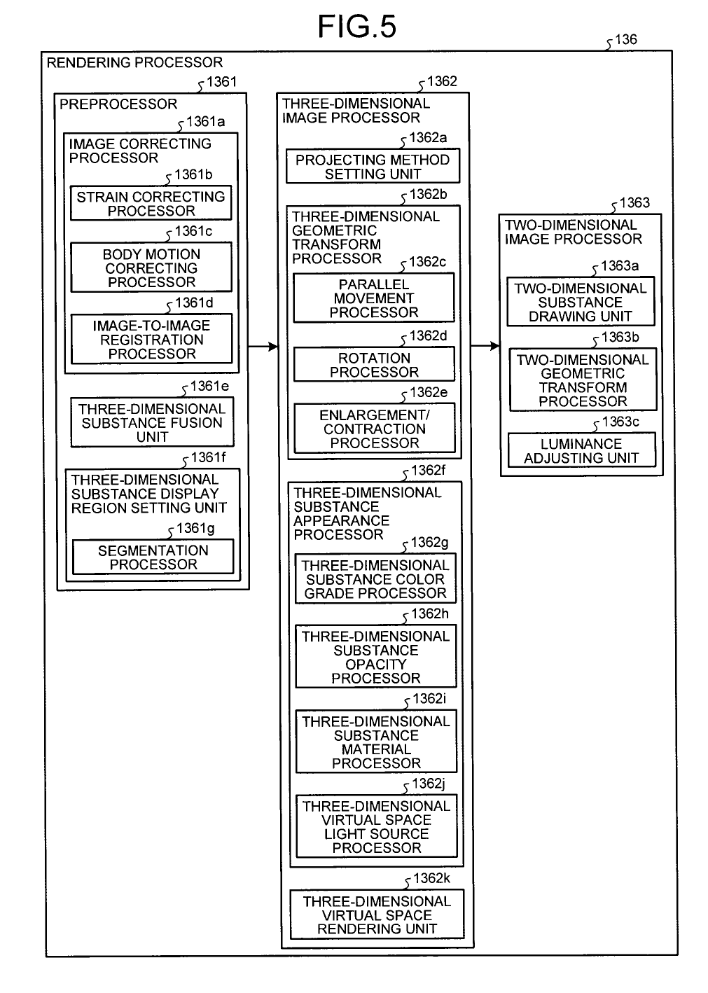

FIG. 5 is a diagram for explaining a configuration example of the rendering processor as illustrated in FIG. 4. As illustrated in FIG. 5, the rendering processor 136 includes a preprocessor 1361, a three-dimensional image processor 1362, and a two-dimensional image processor 1363. As will be described in detail below, the preprocessor 1361 performs preprocessing on volume data. The three-dimensional image processor 1362 generates parallax images from the volume data on which the preprocessing has been performed. The two-dimensional image processor 1363 generates parallax images obtained by superimposing various types of information on a stereoscopic image.

The preprocessor 1361 performs various pieces of preprocessing when the rendering processing is performed on the volume data. In the example as illustrated in FIG. 5, the preprocessor 1361 includes an image correcting processor 1361a, a three-dimensional substance fusion unit 1361e, and a three-dimensional substance display region setting unit 1361f.

The image correcting processor 1361a performs image correcting processing when processing two types of volume data as one volume data. In the example as illustrated in FIG. 5, the image correcting processor 1361a includes a strain correcting processor 1361b, a body motion correcting processor 1361c, and an image-to-image registration processor 1361d. For example, the image correcting processor 1361a performs image correcting processing when processing volume data of a PET image generated by the PET-CT device and volume data of an X-ray CT image as one volume data. Furthermore, the image correcting processor 1361a performs image correcting processing when processing volume data of a T1-weighted image and volume data of a T2-weighted image that have been generated by the MRI device as one volume data.

The strain correcting processor 1361b of the image correcting processor 1361a corrects strain of data due to a collecting condition at the time of data collection by the medical image diagnostic device 110 for individual volume data. In addition, the body motion correcting processor 1361c corrects movement due to a body motion of a subject at the time of collection of data that is used for generating individual volume data. In addition, the image-to-image registration processor 1361d performs registration between two pieces of volume data on which correcting processing has been performed by the strain correcting processor 1361b and the body motion correcting processor 1361c using a cross-correlation method, for example.

The three-dimensional substance fusion unit 1361e fuses a plurality of pieces of volume data on which registration has been performed by the image-to-image registration processor 1361d together. It is to be noted that processing by the image correcting processor 1361a and the three-dimensional substance fusion unit 1361e is omitted when rendering processing is performed on single volume data.

The three-dimensional substance display region setting unit 1361f sets a display region corresponding to a display target organ specified by a user. In the example as illustrated in FIG. 5, the three-dimensional substance display region setting unit 1361f has a segmentation processor 1361g. The segmentation processor 1361g of the three-dimensional substance display region setting unit 1361f extracts an organ such as a heart, a lung, and a blood vessel that has been specified by the user with a region growing method based on a pixel value (voxel value) of the volume data, for example.

It is to be noted that when a display target organ has not been specified by the user, the segmentation processor 1361g does not perform segmentation processing. On the other hand, when a plurality of display target organs have been specified by the user, the segmentation processor 1361g extracts the corresponding plurality of organs. Furthermore, processing by the segmentation processor 1361g is executed based on a fine adjustment request from the user by referring to a rendering image, again, in some cases.

The three-dimensional image processor 1362 performs volume rendering processing on volume data after the preprocessing on which the preprocessor 1361 has performed the processing. In the example as illustrated in FIG. 5, the three-dimensional image processor 1362 includes a projecting method setting unit 1362a, a three-dimensional geometric transform processor 1362b, a three-dimensional substance appearance processor 1362f, and a three-dimensional virtual space rendering unit 1362k as processors that perform the volume rendering processing.

The projecting method setting unit 1362a determines a projecting method for generating a stereoscopic image. For example, the projecting method setting unit 1362a determines whether the volume rendering processing is executed by a parallel projecting method or a perspective projecting method.

The three-dimensional geometric transform processor 1362b determines information for converting volume data on which the volume rendering processing is to be executed in a three-dimensional geometric manner. In the example as illustrated in FIG. 5, the three-dimensional geometric transform processor 1362b includes a parallel movement processor 1362c, a rotation processor 1362d, and an enlargement/contraction processor 1362e. The parallel movement processor 1362c of the three-dimensional geometric transform processor 1362b determines a movement amount for which volume data is moved in parallel when a viewpoint position has been moved in parallel at the time of the volume rendering processing. The rotation processor 1362d determines a movement amount for which volume data is moved rotationally when the viewpoint position has been moved rotationally at the time of the volume rendering processing. Furthermore, the enlargement/contraction processor 1362e determines an enlargement factor or a contraction factor of volume data when a stereoscopic image has been requested to be enlarged or contracted.

The three-dimensional substance appearance processor 1362f includes a three-dimensional substance color grade processor 1362g, a three-dimensional substance opacity processor 1362h, a three-dimensional substance material processor 1362i, and a three-dimensional virtual space light source processor 1362j. The three-dimensional substance appearance processor 1362f determines a display state of a stereoscopic image that is displayed for a user by displaying parallax images by these processors based on a request from the user, for example.

The three-dimensional substance color grade processor 1362g determines a color grade of color to be added to each region obtained by performing the segmentation on volume data. Furthermore, the three-dimensional substance opacity processor 1362h is a processor that determines opacity of each of voxels constituting each region obtained by performing the segmentation on the volume data. A region behind a region of which opacity has been determined to be “100%” on volume data is not drawn on parallax images. On the other hand, a region of which opacity has been determined to be “0%” on volume data is not drawn out on parallax images.

The three-dimensional substance material processor 1362i determines a material of each region obtained by performing the segmentation on volume data so as to adjust texture when the region is drawn out. When the volume rendering processing is performed on volume data, the three-dimensional virtual space light source processor 1362j determines a position of a virtual light source that is installed in a three-dimensional virtual space and a type of the virtual light source. As the type of the virtual light source, a light source that emits parallel light beam at infinity and a light source that emits radial light beam from a viewpoint are included.

The three-dimensional virtual space rendering unit 1362k performs volume rendering processing on volume data so as to generate parallax images. Furthermore, the three-dimensional virtual space rendering unit 1362k uses various types of information determined by the projecting method setting unit 1362a, the three-dimensional geometric transform processor 1362b, and the three-dimensional substance appearance processor 1362f if necessary when performing the volume rendering processing.

The three-dimensional virtual space rendering unit 1362k receives rendering conditions from the controller 135 so as to perform the volume rendering processing on volume data in accordance with the received rendering conditions. The rendering conditions are received from a user through the input unit 131, are set initially, or are received from the terminal device 140 through the communication unit 133. In this case, the above-described projecting method setting unit 1362a, three-dimensional geometric transform processor 1362b, and three-dimensional substance appearance processor 1362f determine necessary various types of information in accordance with the rendering conditions. Then, the three-dimensional virtual space rendering unit 1362k generates a stereoscopic image using the determined various types of information.

It is to be noted that the rendering condition is a “parallel projecting method” or a “perspective projecting method”, for example. For example, the rendering conditions are a “reference viewpoint position and a parallax angle”. Furthermore, the rendering conditions are “parallel movement of the viewpoint position”, “rotational movement of the viewpoint position”, “enlargement of a stereoscopic image”, and “contraction of a stereoscopic image”, for example. Furthermore, the rendering conditions are a “color grade to be added”, “transparency”, “texture”, a “position of the virtual light source”, and a “type of the virtual light source”.

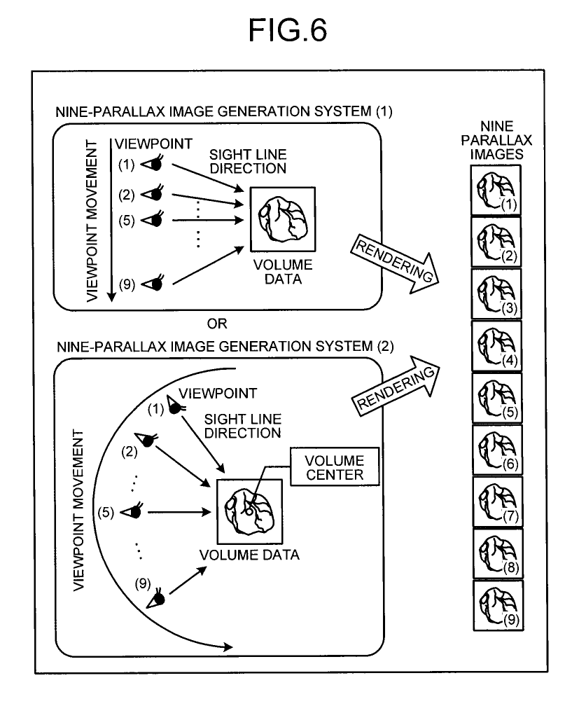

FIG. 6 is a view for explaining an example of the volume rendering processing in the first embodiment. For example, as illustrated in “nine-parallax image generation method (1)”, it is assumed that the three-dimensional virtual space rendering unit 1362k receives the parallel projecting method, and further receives a reference viewpoint position of (5) and a parallax angle of “1 degree”, as rendering conditions. In this case, the three-dimensional virtual space rendering unit 1362k moves a viewpoint position to (1) to (9) in parallel at an interval of the parallax angle of “1 degree” so as to generate nine parallax images of which parallax angles (angles between sight line directions) are different from one another by 1 degree for each by the parallel projecting method. It is to be noted that when the parallel projecting method is employed, the three-dimensional virtual space rendering unit 1362k sets a light source that emits parallel light beam at infinity along sight line directions.

Alternatively, as illustrated in “nine-parallax image generation method (2)” in FIG. 6, it is assumed that the three-dimensional virtual space rendering unit 1362k receives the perspective projecting method, and further receives a reference viewpoint position of (5) and a parallax angle of “1 degree”, as rendering conditions. In this case, the three-dimensional virtual space rendering unit 1362k moves a viewpoint position to (1) to (9) rotationally at an interval of the parallax angle of “1 degree” so as to generate nine parallax images of which parallax angles are different from one another by 1 degree for each by the perspective projecting method. At this time, the three-dimensional virtual space rendering unit 1362k moves the viewpoint position rotationally about the gravity center of a cut surface of volume data that is present on a flat surface for which the viewpoint is moved. In other words, the three-dimensional virtual space rendering unit 1362k moves the viewpoint position rotationally not about the gravity center of a three-dimensional volume but about the gravity center of a two-dimensional cut surface so as to generate nine parallax images. It is to be noted that when the parallel projecting method is employed, the three-dimensional virtual space rendering unit 1362k sets a point light source or a surface light source that emits light three-dimensionally radially about a sight line direction for each viewpoint. Furthermore, when the perspective projecting method is employed, the viewpoints (1) to (9) may be moved in parallel depending on rendering conditions.

It is to be noted that the three-dimensional virtual space rendering unit 1362k may perform volume rendering processing in which the parallel projecting method and the perspective projecting method are used in combination in the following manner. That is, the three-dimensional virtual space rendering unit 1362k sets a light source that emits light two-dimensionally radially about each sight line direction in a longitudinal direction of a volume rendering image to be displayed and emits parallel light beam at infinity along each sight line direction in a lateral direction of the volume rendering image to be displayed.

In the example as illustrated in FIG. 6, a projecting method, a reference viewpoint position, and a parallax angle are received as the rendering conditions. However, when other conditions are received as the rendering conditions, the three-dimensional virtual space rendering unit 1362k generates nine parallax images while reflecting each rendering condition in the same manner.

It is to be noted that the three-dimensional virtual space rendering unit 1362k also has a function of reconstructing an MPR image from volume data by performing multi planer reconstruction (MPR) in addition to the volume rendering. Furthermore, the three-dimensional virtual space rendering unit 1362k also has functions of performing “curved MPR” as MPR and performing “intensity projection”.

Furthermore, overlay images on which various types of information (scale, patient name, test item, and the like) are drawn may be superimposed as overlays while the parallax images generated by the three-dimensional image processor 1362 from the volume data are used as underlays. In this case, the two-dimensional image processor 1363 performs image processing on the overlay images as the overlays and the parallax images as the underlays so as to generate parallax images on which the overlay images have been superimposed. In the example as illustrated in FIG. 5, the two-dimensional image processor 1363 includes a two-dimensional substance drawing unit 1363a, a two-dimensional geometric transform processor 1363b, and a luminance adjusting unit 1363c. It is to be noted that in order to reduce drawing processing costs of various types of information, only one overlay may be drawn and the one overlay may be superimposed on each of the nine parallax images as the underlays so as to generate nine parallax images on which the overlay image has been superimposed.

The two-dimensional substance drawing unit 1363a draws various types of information that are drawn out on the overlay(s). Furthermore, the two-dimensional geometric transform processor 1363b moves positions of various types of information to be drawn out on the overlay(s) in parallel or rotationally, or enlarges or contracts various types of information to be drawn out on the overlay(s). In addition, the luminance adjusting unit 1363c adjusts luminance of the overlay(s) and the underlays in accordance with parameters for image processing such as a gradation, a window width (WW) and a window level (WL) of the stereoscopic display monitor as an output destination, for example. Furthermore, the luminance adjusting unit 1363c performs luminance converting processing on a rendering image, for example.

For example, the parallax images generated by the rendering processor 136 are stored once in the storage unit 134 by the controller 135, and then, are transmitted to the image storage device 120 through the communication unit 133. Thereafter, the terminal device 140 acquires the parallax images on which the overlay image has been superimposed from the image storage device 120, and converts the parallax images into intermediate images arranged in a predetermined format (for example, grid form), for example. Then, the terminal device 140 displays the intermediate images on the stereoscopic display monitor. With this, the terminal device 140 can display a stereoscopic image on which various types of information (scale, patient name, test item, and the like) have been drawn out for a physician or a laboratory technician as a user.

As described above, the rendering processor 136 generates parallax images from volume data under control by the controller 135. Next, the controller 135 in the first embodiment is described in detail.

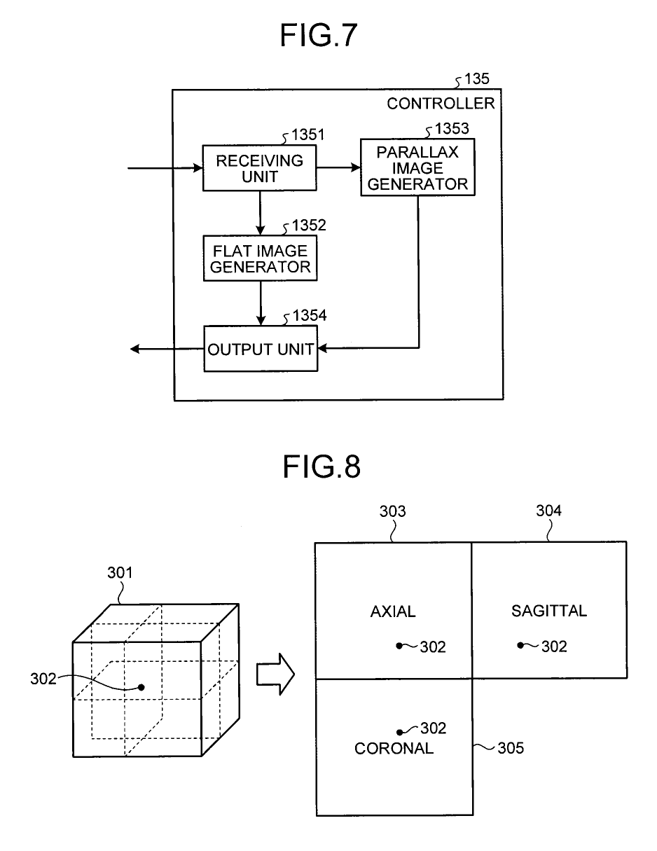

FIG. 7 is a diagram illustrating an example for explaining details of the controller in the first embodiment. As illustrated in FIG. 7, the controller 135 includes a receiving unit 1351, a flat image generator 1352, a parallax image generator 1353, and an output unit 1354.

The receiving unit 1351 receives setting of a region of interest on a stereoscopic image of a subject that is displayed on the workstation 130 or the terminal device 140. For example, the receiving unit 1351 receives setting of an arbitrary cross section on the stereoscopic image, receives setting of an arbitrary partial region on the arbitrary cross section, and receives setting of an arbitrary coordinate point on the stereoscopic image.

For example, the receiving unit 1351 receives setting of an arbitrary axial surface, an arbitrary sagittal surface, an arbitrary coronal surface, or an arbitrary oblique cross section obtained by rotating the cross section about a rotation axis specified by a user on a stereoscopic image of a subject. It is to be noted that the receiving unit 1351 may further receive setting of an arbitrary coordinate point on the arbitrary cross section in addition to setting of the cross section on the stereoscopic image.

Furthermore, the receiving unit 1351 may receive setting of an arbitrary part on the arbitrary axial surface, the arbitrary sagittal surface, the arbitrary coronal surface, and the arbitrary oblique cross section obtained by rotating the cross section about the rotation axis specified by the user on the stereoscopic image of the subject, for example. Furthermore, the receiving unit 1351 may receive setting of an arbitrary coordinate point on the stereoscopic image of the subject, for example.

It is to be noted that setting of a region of interest that is received by the receiving unit 1351 is set by a user who uses the terminal device 140 with an arbitrary method, for example. For example, setting of the region of interest that is received by the receiving unit 1351 is input to the input unit 131 by the user, or is input to the terminal device 140 by the user so as to be input to the communication unit 133 from the terminal device 140.

Then, an example of processing of receiving setting of a region of interest is described simply. For example, if the receiving unit 1351 receives an instruction to start processing for receiving setting of a region of interest from the user, the receiving unit 1351 outputs rendering conditions under which parallax images for displaying a stereoscopic image on which an arbitrary coordinate point or an arbitrary cross section is displayed are generated to the rendering processor 136. Then, the receiving unit 1351 causes the stereoscopic display monitor to display the parallax images generated by the rendering processor 136. That is to say, the receiving unit 1351 controls the stereoscopic display monitor so as to display the stereoscopic image on which the arbitrary coordinate point or the arbitrary cross section is displayed as the region of interest. In addition, if the receiving unit 1351 receives an operation of changing a position of the arbitrary coordinate point, an operation of changing a position of the cross section, an operation of changing a shape of a partial region on the cross section, an operation of further setting a coordinate point on the cross section, or the like, the receiving unit 1351 outputs rendering conditions under which parallax images for displaying a stereoscopic image onto which the received operation content has been reflected are generated to the rendering processor 136. Then, the receiving unit 1351 causes the stereoscopic display monitor to display the parallax images generated by the rendering processor 136. Thereafter, if the receiving unit 1351 receives a determination operation from the user, the receiving unit 1351 receives a coordinate point or a cross section at the time of the reception as a region of interest. Note that the above-described processing of receiving setting of a region of interest is an example merely and the processing is not limited thereto. The receiving unit 1351 may receive setting of a region of interest with an arbitrary method.

The flat image generator 1352 generates a flat image of a cut surface of a subject that is generated by cutting the subject along a plane corresponding to the region of interest received by the receiving unit 1351 based on volume data of the subject stored in the image storage device 120. Note that the image storage device 120 is also referred to as a “predetermined storage device”. For example, the flat image generator 1352 generates a flat image of an arbitrary cross section received by the receiving unit 1351. For example, the flat image generator 1352 generates a multi planar reformat image (MPR image).

A case where the receiving unit 1351 has received setting of an arbitrary coordinate point is further described with reference to FIG. 8. FIG. 8 is a view illustrating an example of a flat image that is generated by the flat image generator in the first embodiment. In FIG. 8, a stereoscopic image of a subject is illustrated to be a cube for convenience of description. A left portion in FIG. 8 illustrates setting of an arbitrary coordinate point 302 on a stereoscopic image 301 of a subject. A right portion of FIG. 8 illustrates an example of the generated flat image. In the example as illustrated in FIG. 8, when the arbitrary coordinate point 302 has been set, the flat image generator 1352 generates a flat image 304 of a cut surface that is generated by cutting the subject along a sagittal surface including the set coordinate point 302. In the same manner, the flat image generator 1352 generates a flat image 305 of a cut surface that is generated by cutting the subject along a coronal surface including the coordinate point 302. Furthermore, in the same manner, the flat image generator 1352 generates a flat image 303 that is generated by cutting the subject along an axial surface including the coordinate point 302.

Furthermore, when an arbitrary cross section has been received by the receiving unit 1351, the flat image generator 1352 generates a flat image of a cut surface that is generated by cutting a subject along the received cross section.

Furthermore, if an arbitrary partial region on an arbitrary cross section has been received by the receiving unit 1351, the flat image generator 1352 generates a flat image corresponding to the arbitrary partial region on a cut surface that is generated by cutting a subject along the received cross section.

The parallax image generator 1353 controls the rendering processor 136 so as to generate parallax images. To be more specific, the parallax image generator 1353 generates parallax images for displaying a stereoscopic image on which guidance indicating a region of interest received by the receiving unit 1351 is displayed based on volume data of a subject stored in the image storage device 120. For example, the parallax image generator 1353 generates parallax images for displaying a stereoscopic image on which guidance indicating an arbitrary cross section or an arbitrary coordinate point that has been received by the receiving unit 1351 is displayed.

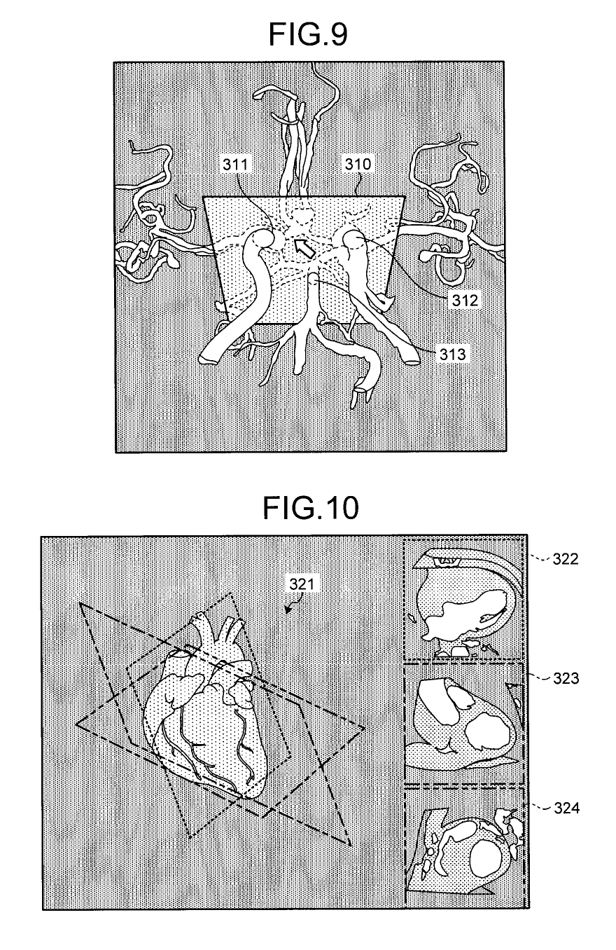

FIG. 9 is a view illustrating an example of a stereoscopic image that is displayed by displaying parallax images generated by the parallax image generator in the first embodiment. As illustrated in FIG. 9, the parallax image generator 1353 generates parallax images for displaying a stereoscopic image on which a figure having transparency is displayed at a position corresponding to a flat image generated by the flat image generator 1352 based on volume data of a subject stored in the image storage device 120. In the example as illustrated in FIG. 9, the parallax image generator 1353 generates parallax images for displaying a stereoscopic image on which a Figure 310 having transparency is displayed. That is to say, the Figure 310 having transparency serves as guidance indicating a position of an arbitrary cross section received by the receiving unit 1351.

The parallax image generator 1353 may further generate parallax images for displaying a stereoscopic image on which portions 311 to 313 having the same coordinate point as the figure having transparency are distinguishable from other portions on the subject included in the stereoscopic image. In other words, portions in which the figure having transparency and the subject included in the stereoscopic image are overlapped with each other may be displayed so as to be distinguished from other portions. That is to say, a contour portion of the subject on a cut surface that is generated by cutting the subject along a plane corresponding to a region of interest may be displayed so as to be distinguished from other portions. For example, the parallax image generator 1353 may replace pixels of the contour portion of the stereoscopic image on the portions in which the figure having transparency and the subject included in the stereoscopic image are overlapped with each other by a predetermined color or a complementary color.

The parallax image generator 1353 may use an arbitrary shape as a shape of the figure having transparency. For example, the parallax image generator 1353 may use the same shape as the flat image generated by the flat image generator 1352. Furthermore, hereinafter, description is made using a case where the parallax image generator 1353 uses a two-dimensional surface having no thickness as the shape of the figure having transparency as an example. However, the shape of the figure having transparency is not limited thereto and may be a stereoscopic shape having an arbitrary thickness. If the figure having transparency has a thickness, even when a stereoscopic image is rotated and so on, a position of the figure can be recognized easily. It is to be noted that the figure having transparency is used for displaying a position of the region of interest. In other words, the figure having transparency is used for checking a position on the stereoscopic image that corresponds to a position on the flat image.

The output unit 1354 outputs the flat image generated by the flat image generator 1352. To be more specific, the output unit 1354 outputs the flat image to the terminal device 140 that can display a stereoscopic image or a device that is different from the terminal device 140 and can display a stereoscopic image. Therefore, the flat image is displayed together with the stereoscopic image. Furthermore, the output unit 1354 outputs the parallax images generated by the parallax image generator 1353 in addition to the flat image, for example. With this, a stereoscopic image on which the figure having transparency is provided on the region of interest is displayed on the terminal device 140 or the workstation 130.

Hereinafter, description is made using a case where parallax images for displaying a stereoscopic image and a flat image are output to the same device for convenience of explanation. However, the embodiment is not limited thereto and the output unit 1354 may output the parallax images for displaying a stereoscopic image and the flat image to different devices.

The output unit 1354 may output the parallax images for displaying a stereoscopic image and the flat image as image data. Alternatively, the output unit 1354 may output them as video data in which the parallax images for displaying a stereoscopic image and the flat image are combined. Description is further made using a case where the output unit 1354 outputs the parallax images for displaying a stereoscopic image and the flat image to the terminal device 140 as image data. In this case, the terminal device 140, which will be described later, controls the received parallax images and flat image so as to be displayed so that the stereoscopic image and the flat image are displayed together for a user. Then, description is further made using a case where the output unit 1354 outputs video data in which the parallax images for displaying a stereoscopic image and the flat image are combined to the terminal device 140. In this case, a controller 145 of the terminal device 140 displays the received video data so that the parallax images and the flat image are displayed from a display unit 142. As a result, the stereoscopic image and the flat image are displayed together for a user.

FIG. 10 is a view illustrating examples of a stereoscopic image and flat images that are displayed on the terminal device as a result of output from the output unit in the first embodiment. As illustrated in FIG. 10, the terminal device 140 or the workstation 130 displays flat images 322 to 324 corresponding to arbitrary cross sections together with a stereoscopic image 321.

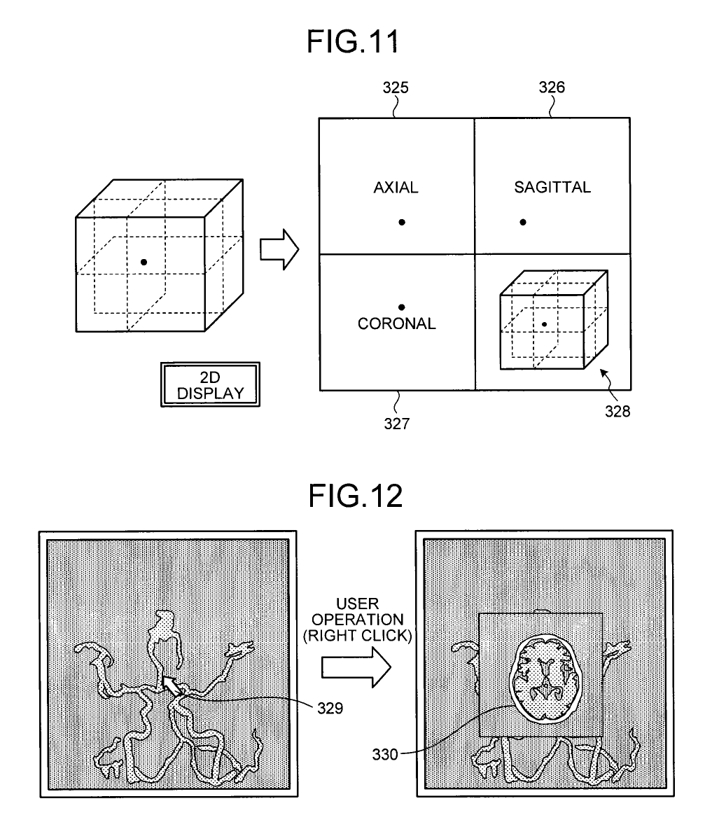

When an instruction to display a flat image has been received from a user after the receiving unit 1351 has received setting of a region of interest, the output unit 1354 may output the flat image to the terminal device 140. FIG. 11 is a view illustrating examples of a stereoscopic image and flat images that are displayed on the terminal device as a result of output from the output unit in the first embodiment. As illustrated in a left portion of FIG. 11, if information indicating that “two-dimensional display” indicating an instruction to display a flat image has been clicked by a user on the terminal device 140 has been received as illustrated in a lower left portion of FIG. 11 after the receiving unit 1351 has received setting of a region of interest, the output unit 1354 may output flat images 325 to 327 as illustrated in a right portion of FIG. 11. That is to say, the flat images 325 to 327 are displayed on the terminal device 140. It is to be noted that in the example as illustrated in FIG. 11, the receiving unit 1351 has received setting of an arbitrary coordinate point in the same manner as FIG. 8 for convenience of explanation. However, the embodiment is not limited thereto. The above description may be applied to a case where the receiving unit 1351 has received setting of an arbitrary region of interest. Furthermore, in the example as illustrated in FIG. 11, a stereoscopic image 328 is output together with the flat images 325 to 327. However, the embodiment is not limited thereto and the stereoscopic image 328 may not be output.

The above description has been made using a case in which the output unit 1354 switches whether a flat image is displayed, as an example. However, the embodiment is not limited thereto. For example, if a region of interest has been set by the receiving unit 1351, the output unit 1354 transmits a flat image to the terminal device 140. Thereafter, the terminal device 140 may switch whether the flat image is displayed. For example, the terminal device 140 may switch whether the flat image is displayed based on whether an operation of clicking “2D display” has been received from a user.

In addition, the output unit 1354 may control such that a flat image is displayed at a position of a cursor used by a user. For example, if information indicating the position of the cursor has been received from the terminal device 140, the output unit 1354 may generate video data on which a flat image is displayed at the received position of the cursor and output the video data to the terminal device 140.

FIG. 12 is a view illustrating an example when a flat image is displayed at a position of a cursor in the first embodiment. If a cursor 329 is present as illustrated in a left portion of FIG. 12, a flat image 330 is displayed at a position at which the cursor 329 has been present as illustrated in a right portion of FIG. 12. In the example as illustrated in FIG. 12, when an operation of right click or the like has been performed by a user, the flat image 330 is displayed at the position at which the cursor 329 has been present.

The above description has been made using a case in which the output unit 1354 generates video data on which a flat image is displayed at the received position of a cursor and outputs the generated video data. However, the embodiment is not limited thereto. For example, if a region of interest is set by the receiving unit 1351, the output unit 1354 may transmit a flat image to the terminal device 140 and the controller 145 of the terminal device 140 may identify a position of a cursor and control such that the flat image is displayed at the position of the cursor.

A case where the terminal device 140 or the workstation 130 includes a decreasing controller that controls directivity of light that is given by a lenticular lens layer 331 provided on a display surface on which a stereoscopic image is displayed in a decreasing direction is further described.

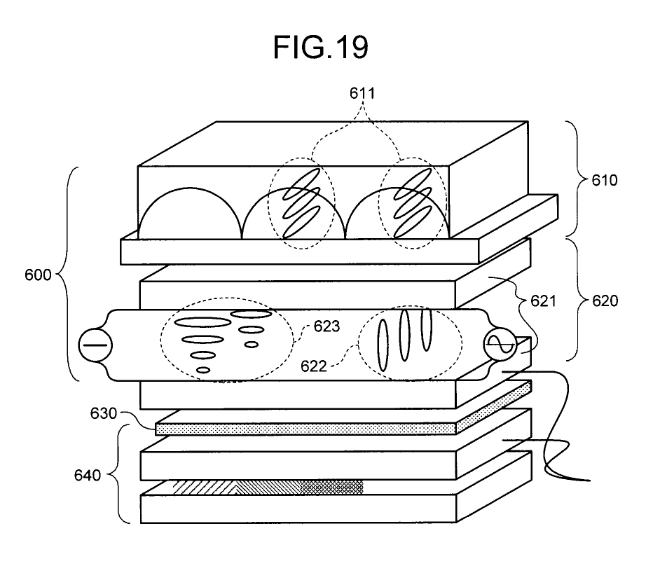

FIG. 19 is a view for explaining an example in which directivity of light that is given by the lenticular lens layer is increased or decreased in the first embodiment. For example, when the directivity of light that is given by the lenticular lens layer is increased or decreased, a liquid crystal lens portion 600 is provided on a display surface 630 of a liquid crystal 640 to which light (image) is output. As illustrated in FIG. 19, the liquid crystal lens portion 600 includes a lenticular lens layer 610 and a liquid crystal portion 620. The liquid crystal lens portion 600 is installed on the display surface 630 such that the liquid crystal portion 620 is sandwiched between the lenticular lens layer 610 and the display surface 630.

The lenticular lens layer 610 has lenticular lenses having lens shapes. Furthermore, the lenticular lens layer 610 has lens upper portions (upper portions of the lenticular lenses) and lens lower portions (hollow wall portions on lower portions of the lenticular lenses). The lens upper portions are formed with a common resin. Liquid crystal is enclosed in the lens lower portions in a solidified state. The liquid crystal that has a nano-level linear configuration and is aligned in a specified direction is enclosed in the lens lower portions of the lenticular lens layer 610. For example, as illustrated in FIG. 19, liquid crystal 611 in the lens lower portion has a nano-level linear configuration in a circular column direction of the lenticular lenses having semicircular column shapes and is enclosed such that a plurality of linear configurations are aligned in a longitudinal direction (up-down direction in FIG. 19).

As illustrated in FIG. 19, the liquid crystal portion 620 is formed by sandwiching liquid crystal between electrode substrates 621. Reference numerals 622 and 623 in FIG. 19 indicate polarization directions of light that is incident on the liquid crystal sandwiched between the electrode substrates 621 from a direction of the display surface 630. To be more specific, the reference numeral 622 in FIG. 19 indicates a state where the polarization direction of light is not changed when the light is incident on the liquid crystal to which voltage is applied. On the other hand, the reference numeral 623 in FIG. 19 indicates a state where a polarization direction of light is rotated by 90 degrees when the light is incident on the liquid crystal to which voltage is not applied.

The decreasing controller controls voltage to be applied from the electrode substrates 621 as illustrated in FIG. 19 so as to increase or decrease directivity of light that is given by the lenticular lens layer 610. With this, the decreasing controller switches the display unit 132 between a planar view mode and a stereoscopic view mode. For example, when display information given to image data as a display target is for planar view, the decreasing controller controls voltage substrates to apply voltage. That is to say, a polarization direction of light that is incident from the display surface 630 is not changed as illustrated in the reference numeral 622 of FIG. 19 and the light is incident on the lens in a longitudinal direction. At this time, the polarization direction of the light is identical to the longitudinal direction as an alignment direction of the liquid crystal 611 in the lenses. As a result, a light traveling speed is not changed and there arises no difference in a refractive index between the lens lower portions and the lens upper portions. Therefore, the light travels straight. That is to say, the decreasing controller controls the voltage substrates to apply voltage so as to switch the display unit 132 to be in the planar view mode in which directivity of the light is decreased.

Furthermore, for example, when display information given to image data as a display target is for stereoscopic view, the decreasing controller controls the voltage substrates so as not to apply voltage. That is to say, light is incident on the lens in a state where a polarization direction of the light that is incident from the display surface 630 is rotated by 90 degrees (changed in the lateral direction) as illustrated in the reference numeral 623 of FIG. 19. At this time, the polarization direction of the light is orthogonal to the longitudinal direction as the alignment direction of the liquid crystal 611 in the lenses. As a result, a light traveling speed is lowered and a difference in the refractive index between the lens lower portions and the lens upper portions is generated. Therefore, the light refracts. That is to say, the decreasing controller controls the voltage substrates so as not to apply voltage so as to switch the display unit 132 to be in the stereoscopic view mode in which directivity of the light is increased.

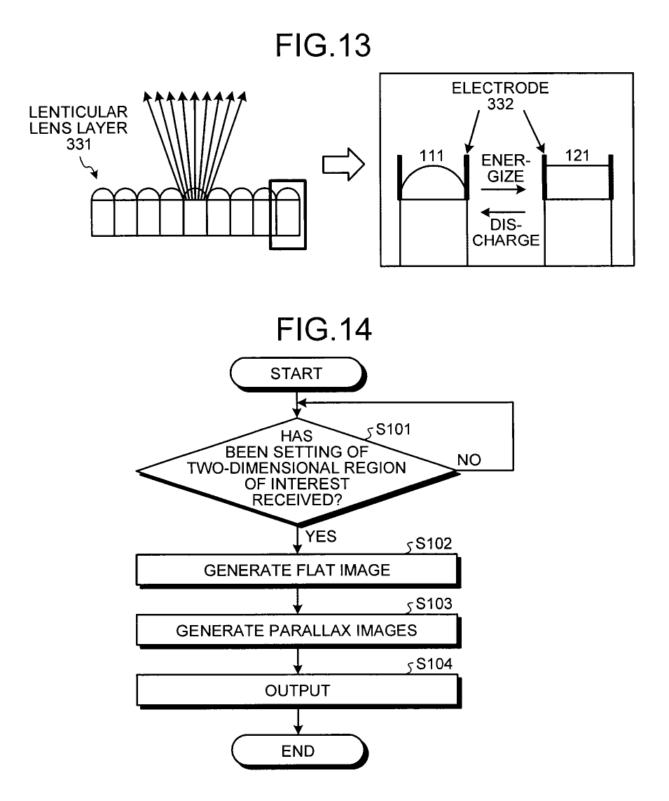

FIG. 13 is a view illustrating an example of a method of controlling directivity of light that is given by the lenticular lens layer in a decreasing direction. In the example as illustrated in FIG. 13, the lenticular lens layer 331 is sandwiched between electrodes 332. As illustrated in a left portion to a right portion of FIG. 13, the lenticular lens layer 331 changes into a planar shape from a lens shape if the electrodes are energized. In other words, the directivity of light is decreased. On the other hand, as illustrated in the right portion to the left portion of FIG. 13, the lenticular lens layer 331 forms a lens shape if the electrodes are discharged. That is to say, in the example as illustrated in FIG. 13, the decreasing controller of the terminal device 140 controls the directivity of light that is given by the lenticular lens layer by energizing or discharging the electrodes. It is to be noted that a method of controlling the directivity of the light that is given by the lenticular lens layer as illustrated in FIG. 13 in the decreasing direction is an example merely and an arbitrary method may be used.

The output unit 1354 may cause a flat image to be displayed on a region of a display surface on which directivity of light has been controlled in the decreasing direction by the decreasing controller on the display surface of the terminal device 140 or the workstation 130. For example, when the output unit 1354 outputs the flat image as video data, the output unit 1354 outputs an instruction to control directivity of light that is given by the lenticular lens layer in the decreasing direction for a region corresponding to the flat image together with the video data. With this, the flat image is displayed on a region of the display surface on which directivity of light has been controlled in the decreasing direction. For example, when the output unit 1354 outputs parallax images and a flat image as individual image data, the output unit 1354 outputs an instruction to control directivity of light that is given by the lenticular lens layer in the decreasing direction for a region corresponding to the flat image together with the parallax images and the flat image. With this, the controller 145 of the terminal device 140 displays the flat image on a region of the display surface on which directivity of light has been controlled in the decreasing direction.

The above description has been made using a case where the output unit 1354 outputs an instruction to control the directivity of light that is given by the lenticular lens layer in the decreasing direction. However, the embodiment is not limited thereto. For example, when a region of interest is set by the receiving unit 1351, the output unit 1354 transmits a flat image to the terminal device 140. Then, when the flat image is displayed, the controller 145 of the terminal device 140 may control autonomously such that the flat image is displayed on a region of the display surface on which directivity of light that is given by the lenticular lens layer is controlled in the decreasing direction.

### Processing in First Embodiment

An example of flow of processing by the image processing device according to the first embodiment is described with reference to FIG. 14. FIG. 14 is a flowchart illustrating an example of the flow of the processing by the image processing device in the first embodiment.

As illustrated in FIG. 14, if the receiving unit 1351 receives setting of a region of interest on a stereoscopic image of a subject that is displayed on the workstation 130 or the terminal device 140 (Yes at S101), the flat image generator 1352 generates a flat image corresponding to the received region of interest based on volume data of the subject stored in the image storage device 120 (S102). That is to say, the flat image generator 1352 generates a flat image of a cut surface of the subject that is generated by cutting the subject along a plane corresponding to the region of interest. For example, the flat image generator 1352 generates an MPR image corresponding to an arbitrary cross section received by the receiving unit 1351.

Then, the parallax image generator 1353 generates parallax images for displaying a stereoscopic image on which guidance indicating the region of interest received by the receiving unit 1351 based on the volume data of the subject stored in the image storage device 120 (S103). For example, the parallax image generator 1353 generates parallax images for displaying a stereoscopic image on which a figure having transparency is displayed at a position corresponding to an arbitrary cross section received by the receiving unit 1351.

Thereafter, the output unit 1354 outputs the flat image. To be more specific, the output unit 1354 outputs the parallax images generated by the parallax image generator 1353 in addition to the flat image (S104). That is to say, the output unit 1354 causes to be displayed the flat image together with the stereoscopic image.

It is to be noted that the above-described processing procedures are not limited to the above-described order and may be changed appropriately in a range of being consistent with the processing contents. For example, the above processing at S103 may not be executed. In this case, the flat image is displayed together with the stereoscopic image that is displayed on the terminal device 140.

### Effects by First Embodiment

As described above, according to the first embodiment, setting of a region of interest on a stereoscopic image of a subject that is displayed on the terminal device 140 is received. Then, a flat image of a cut surface of the subject that is generated by cutting the subject along a plane corresponding to the received region of interest is generated based on volume data of the subject stored in the image storage device 120. Thereafter, the generated flat image is output. As a result, a positional relationship on the stereoscopic image can be grasped easily. Note that it is difficult to grasp a positional relationship of an image that is desired to be focused when viewing stereoscopically only in some cases. In consideration of the fact, the flat image is displayed in conjunction with the stereoscopic image that is displayed on a 3D monitor. This makes it possible to grasp the positional relationship on the stereoscopic image easily. As a result, the positional relationship between a stereoscopic image on the 3D monitor and an image that is desired to be focused can be made easy to be grasped, for example.

Furthermore, as a result, after a lesion position is specified by using the stereoscopic image, final interpretation of radiogram can be executed easily using the flat image in a conventional manner. As a result, the flow of the interpretation of radiogram from specification of the lesion position to diagnosis is made smooth, thereby performing diagnosis efficiently.

Furthermore, according to the first embodiment, a flat image is output to the terminal device 140 that displays a stereoscopic image or another display device so as to display the flat image together with the stereoscopic image. As a result, a user can view the flat image together with the stereoscopic image.

Furthermore, according to the first embodiment, setting of an arbitrary cross section on a stereoscopic image or an arbitrary region on the arbitrary cross section is received as a region of interest. As a result, a user can view a flat image of a region that the user desires to check.

Furthermore, according to the first embodiment, the terminal device 140 includes the decreasing controller that controls directivity of light that is given by the lenticular lens layer provided on the display surface that displays a stereoscopic image in the decreasing direction. A flat image is displayed on a region of the display surface on which directivity of light has been controlled in the decreasing direction by the decreasing controller on the display surface of the terminal device 140. As a result, the flat image can be displayed with high accuracy while displaying the stereoscopic image. For example, the terminal device 140 displays a flat image on a flattened portion while a portion of the lenticular lens layer is made to be flattened. With this, the flat image can be displayed with high definition. That is to say, when a flat image is displayed on a 3D monitor that can display a glasses-free 3D image, the flat image can be displayed with high definition at an original resolution of the 3D monitor.

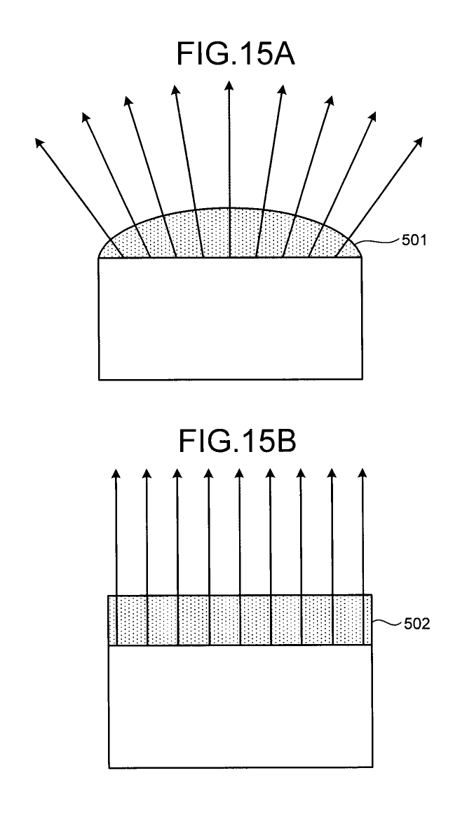

FIGS. 15A and 15B are views illustrating an example of effects obtained in the first embodiment. A lenticular lens 501 in FIG. 15A has a lens shape, and a lenticular lens 502 in FIG. 15B has a planar shape. In FIGS. 15A and 15B, directions of arrows indicate directions of light output from display surfaces. In other words, a user at a position ahead of each arrow recognizes a pixel corresponding to the arrow visually.

When the lenticular lens has a lens shape as illustrated in the lenticular lens 501 in FIG. 15A, an intermediate image is displayed on the display surface so as to display a stereoscopic image for a user with naked eyes. In the example of the lenticular lens 501 as illustrated in FIG. 15A, each of the pixels that are displayed in the arrow directions corresponds to each of pixels that are located at the same position on each of parallax images obtained when a subject is seen from different angles. It is to be noted that in the example of the lenticular lens 501 as illustrated in FIG. 15A, a user at the front visually recognizes pixels for an arrow that directs to the front but does not visually recognize pixels that do not direct to the front.

On the other hand, when the lenticular lens has a planar shape as illustrated in the lenticular lens 502 in FIG. 15B, a flat image is displayed on the display surface so as to display the flat image with high definition for a user. That is to say, in the example of the lenticular lens 502 as illustrated in FIG. 15B, directions of all the arrows direct to the front so that a user at the front can visually recognize all the pixels. The flat image is displayed on the display surface so as to enable the user to visually recognize all the pixels of the flat image that is displayed. This makes it possible to display a flat image with high definition.

Furthermore, according to the first embodiment, parallax images for displaying a stereoscopic image on which a figure having transparency is displayed at a position corresponding to a region of interest based on volume data of a subject stored in the image storage device 120. As a result, a position in the stereoscopic image corresponding to the flat image can be grasped easily.

Furthermore, according to the first embodiment, parallax images for displaying a stereoscopic image on which portions having the same coordinate point as the figure having transparency are distinguishable from other portions of a subject on the subject included in the stereoscopic image. As a result, a relationship between the figure having transparency and the subject can be grasped easily on the stereoscopic image.

### Second Embodiment

Meanwhile, it is possible to execute other embodiments other than the above-described embodiment. Other embodiments are described as follows.

### Transparence

For example, when parallax images for displaying a stereoscopic image on which a figure having transparency is displayed is displayed, the parallax image generator 1353 may set transparency of the figure to arbitrary transparence.

### Interaction of Cursor Position and Figure Having Transparency

Furthermore, for example, the parallax image generator 1353 may generate parallax images for displaying a stereoscopic image on which a figure having transparency is displayed in conjunction with a position of a cursor that is operated by a user. In this case, the parallax image generator 1353 may generate parallax images for displaying a stereoscopic image on which the figure having transparency that is orthogonal to an arbitrary axis is displayed. For example, the parallax image generator 1353 may generate parallax images for displaying a stereoscopic image on which the figure having transparency that is orthogonal to a depth direction is displayed. In other words, the parallax image generator 1353 outputs parallax images for displaying a stereoscopic image on which the figure having transparency is displayed at a position corresponding to the position of the cursor in the z direction as the depth direction. With this, a user can grasp the depth direction of the cursor easily.

### Interaction of Cursor Position and Flat Image

Furthermore, for example, when a flat image is displayed at a position of a cursor, a flat image of a cross section including a coordinate point specified by the cursor may be displayed. For example, a flat image of an axial surface, a flat image of a sagittal surface, and a flat image of a coronal surface may be displayed. In other words, if a coordinate point is specified with the cursor by a user, a cross section including the specified coordinate point may be received as setting of a region of interest. That is to say, when a stereoscopic image including a blood vessel image is displayed, the blood vessel image does not include a bone and a body surface, and a site that is displayed is difficult to be recognized when seen from the outside of the body. In consideration of that fact, a flat image corresponding to a position of the cursor is displayed at the position of the cursor, the site that is being viewed at the present time can be grasped easily.

### Flat Image of Subject That is Displayed as Stereoscopic Image

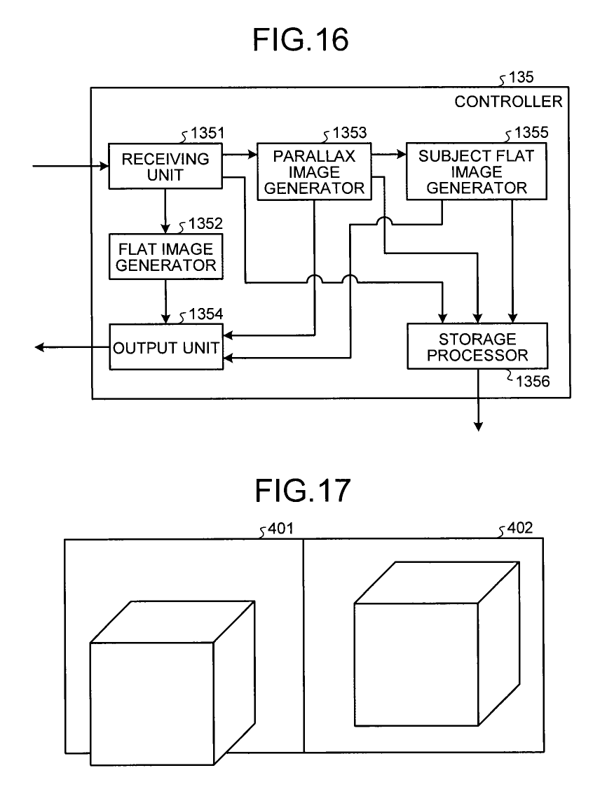

For example, the controller 135 may further include a subject flat image generator 1355 and a storage processor 1356 in addition to the configuration of FIG. 7, as illustrated in FIG. 16. FIG. 16 is a diagram illustrating an example of a configuration of a controller that further includes the subject flat image generator and the storage processor.

The subject flat image generator 1355 further generates a subject flat image as a flat image of a subject that is displayed as a stereoscopic image on the stereoscopic image display device. In other words, the subject flat image generator 1355 generates a flat image of the stereoscopic image that is displayed on the stereoscopic image display device. For example, description is made using a case where the stereoscopic image display device displays a stereoscopic image of a head of a subject for a user. In this case, the subject flat image generator 1355 generates a flat image of the head of the subject. The subject flat image generator 1355 may use an arbitrary one parallax image of parallax images for displaying the stereoscopic image that is displayed on the stereoscopic image display device as a subject flat image. Alternatively, the subject flat image generator 1355 may use one parallax image that has been generated newly by the parallax image generator 1353 as a subject flat image. Furthermore, the subject flat image generator 1355 may generate a flat image of the subject newly based on volume data of the subject stored in the image storage device 120. In addition, the subject flat image generator 1355 may use the same viewpoint as a stereoscopic image that is recognized visually by a user when viewed from a front side of the stereoscopic image display device, as an arbitrary viewpoint. Then, the output unit 1354 may output the flat image generated by the flat image generator 1352 or the subject flat image generator 1355. In the example as illustrated in FIG. 16, the subject flat image generator 1355 receives parallax images generated by the parallax image generator 1353. However, the embodiment is not limited thereto.

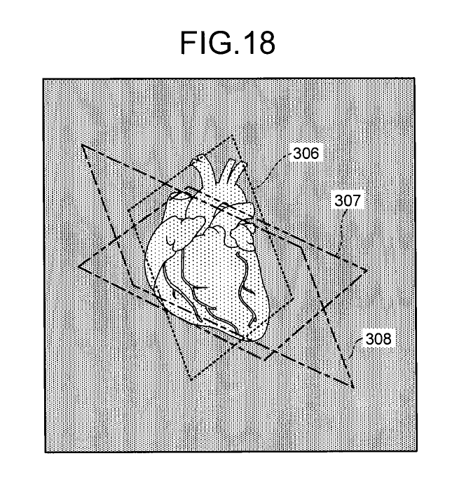

FIG. 17 is a view illustrating an example in which a stereoscopic image and a subject flat image are displayed together. As illustrated in FIG. 17, the terminal device 140 or the workstation 130 displays parallax images 401 for displaying a stereoscopic image and a flat image 402 as images of the same subject. It is to be noted that in the example as illustrated in FIG. 17, an image of a stereoscopic image that is displayed for a user is illustrated as the parallax images 401.

If the storage processor 1356 receives a storage instruction to store an image from a user, the storage processor 1356 stores parallax images for displaying a stereoscopic image of a subject that is displayed on the stereoscopic image display device and a subject flat image generated by the subject flat image generator 1355 in a corresponding manner in a predetermined storage unit. For example, the storage processor 1356 may store the parallax images and the subject flat image in a corresponding manner in the image storage device 120. As is described with a more specific example, the storage processor 1356 stores a plurality of parallax images generated by the parallax image generator 1353 and a subject flat image generated by the subject flat image generator 1355 in a corresponding manner. In the example as illustrated in FIG. 16, the storage processor 1356 receives a storage instruction from the receiving unit 1351, receives parallax images for displaying a stereoscopic image that have been generated by the parallax image generator 1353, and receives a subject flat image generated by the subject flat image generator 1355. However, the embodiment is not limited thereto.

In the example as illustrated in FIG. 16, the controller 135 further includes the subject flat image generator 1355 and the storage processor 1356. However, the embodiment is not limited thereto. The controller 135 may include the subject flat image generator 1355 but may not include the storage processor 1356.

### Frame

FIG. 18 is a view illustrating an example of a stereoscopic image that is displayed by displaying parallax images that are generated by the parallax image generator in the first embodiment. In the example as illustrated in FIG. 18, the parallax image generator 1353 generates parallax images for displaying a stereoscopic image 309 including frames 306 to 308 indicating arbitrary cross sections received by the receiving unit 1351.

### Flat Image Provided in Stereoscopic Image

Furthermore, parallax images for displaying a stereoscopic image on which a flat image is displayed at a position corresponding to a region of interest may be generated and output, for example. To be more specific, on the controller 135 of the image processing device, the flat image generator 1352 generates a flat image having arbitrary transparency. For example, the flat image generator 1352 generates a flat image having transparency of “0%”, generates a flat image having transparency of “50%”, or generates a flat image having arbitrary transparency, for example. The transparency is set by a user, for example.

Then, the parallax image generator 1353 generates a stereoscopic image on which a flat image having arbitrary transparency that has been generated by the flat image generator 1352 is displayed at a position corresponding to the generated flat image based on volume data of a subject stored in the image storage device 120. For example, as is described with reference to the example as illustrated in FIG. 9, the parallax image generator 1353 generates a stereoscopic image on which a flat image having arbitrary transparency is displayed on the figure having transparency as illustrated in FIG. 9. Then, the output unit 1354 outputs the parallax images generated by the parallax image generator 1353. As a result, a position of the flat image on the stereoscopic image can be identified easily by a user.

Furthermore, the parallax image generator 1353 may generate parallax images for displaying a stereoscopic image on which at least one of a portion of a subject at the front side relative to the flat image when seen from a user and a portion thereof at the rear side relative to the flat image when seen from the user has arbitrary transparency. As a result, the flat image can be displayed while displaying the portion at the front side relative to the flat image when seen from the user stereoscopically. Furthermore, the portion at the rear side relative to the flat image when seen from the user can be displayed while displaying the flat image.

In addition, the parallax image generator 1353 may generate parallax images for displaying a stereoscopic image on which at least one of a portion at the front side relative to the flat image when seen from a user and a portion at the rear side relative to the flat image when seen from the user is not displayed.

### Setting of Coordinate Point

Furthermore, when setting of an arbitrary coordinate point has been received by the receiving unit 1351, the flat image generator 1352 may generate a flat image including the arbitrary coordinate point. For example, the flat image generator 1352 may generate at least one of a flat image on an axial surface including the arbitrary coordinate point, a flat image on a sagittal surface including the arbitrary coordinate point, a flat image on a coronal surface including the arbitrary coordinate point, and a flat image of an arbitrary cross section including the arbitrary coordinate point.

### System Configuration

Furthermore, all of or a part of processing that have been described to be performed automatically among the pieces of processing as described in the above embodiments can be performed manually. Alternatively, all of or a part of processing that have been described to be performed manually among the pieces of processing as described in the above embodiments can be performed automatically by a known method. In addition, information (FIGS. 1 to 15B) including processing procedures, control procedures, specific names, and various types of data and parameters as described in the above-described document and drawings can be changed arbitrarily unless otherwise specified.

The constituent components of the devices as illustrated in the drawings are conceptual functionally and are not necessarily required to be configured as illustrated in the drawings physically. That is to say, specific forms of disintegration and integration of the devices are not limited to those as illustrated in the drawings, and all of or a part of them can be configured to be disintegrated or integrated functionally or physically based on an arbitrary unit depending on various loads and usage conditions. For example, the controller 135 of the workstation 130 may be connected through a network as an external device of the workstation 130.

### Others

An image processing program described in the embodiment can be distributed through a network such as the Internet. Furthermore, the image processing program can be also executed by recording the program in a computer readable recording medium and causing a computer to read from the recording medium. For example, the program is recorded in a hard disk, a flexible disk (FD), a compact disk read only memory (CD-ROM), a magnetooptic disc (MO), a digital versatile disk (DVD), a Blu-ray (registered trademark) Disk, or the like.

### Effect of Embodiment

With the image processing device according to at least one of the above-described embodiments, setting of a region of interest on a stereoscopic image of a subject that is displayed on a stereoscopic image display device is received. Then, a flat image of a cut surface of the subject that is generated by cutting the subject along a plane corresponding to the received region of interest is generated based on volume data and the generated flat image is output. This makes it possible to grasp a positional relationship on the stereoscopic image.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing device comprising:
a receiving unit configured to receive setting of a region of interest on parallax images of a subject that are displayed stereoscopically;
a flat image generator configured to generate a flat image of a cut surface of the subject that is generated by cutting the subject along a plane corresponding to the region of interest received by the receiving unit based on volume data of the subject stored in a predetermined storage device; and
an output unit configured to output the flat image generated by the flat image generator.

2. The image processing device according to claim 1, wherein the receiving unit receives setting of an arbitrary cross section on the parallax images or an arbitrary region on the arbitrary cross section as the region of interest.

3. The image processing device according to claim 1, further comprising a display unit configured to be capable of displaying parallax images, wherein
the output unit outputs the flat image to the display unit on which the parallax images are displayed or a display unit that is different from the display unit and on which the parallax images are displayed so as to display the flat image together with the parallax images.

4. The image processing device according to claim 1, further comprising a parallax image generator configured to generate the parallax images for displaying a figure having transparency stereoscopically at a position corresponding to the flat image generated by the flat image generator based on the volume data of the subject stored in the predetermined storage device, wherein
the output unit outputs the parallax images generated by the parallax image generator in addition to the flat image.

5. The image processing device according to claim 1, wherein
the flat image generator generates the flat image having arbitrary transparency,
the image processing device further comprises a parallax image generator configured to generate the parallax images having the flat image having the arbitrary transparency that has been generated by the flat image generator at a position corresponding to the flat image based on the volume data of the subject stored in the predetermined storage device, and
the output unit outputs the parallax images generated by the parallax image generator.

6. The image processing device according to claim 1, further comprising a subject flat image generator configured to generate a subject flat image as a flat image of the subject that is displayed stereoscopically, wherein
the output unit outputs the subject flat image generated by the subject flat image generator.

7. An image processing device comprising:
a receiving unit configured to receive setting of a coordinate point on parallax images of a subject that are displayed stereoscopically;
a flat image generator configured to generate a flat image including the coordinate point received by the receiving unit based on volume data of the subject stored in a predetermined storage device; and
an output unit configured to output the flat image generated by the flat image generator.

8. The image processing device according to claim 7, further comprising a display unit configured to be capable of displaying parallax images, wherein
the output unit outputs the flat image to the display unit on which the parallax images are displayed or a display unit that is different from the display unit and on which the parallax images are displayed so as to display the flat image together with the parallax images.

9. The image processing device according to claim 7, wherein
the display unit includes a decreasing controller configured to control directivity of light that is given by a lenticular lens layer provided on a display surface that displays the parallax images in a decreasing direction, and
the output unit causes the display unit to display the flat surface on a region of the display surface on which directivity of light has been controlled in the decreasing direction by the decreasing controller on the display surface of the display unit.

10. The image processing device according to claim 7, further comprising a parallax image generator configured to generate the parallax images for displaying a figure having transparency stereoscopically at a position corresponding to the flat image generated by the flat image generator based on the volume data of the subject stored in the predetermined storage device, wherein
the output unit outputs the parallax images generated by the parallax image generator in addition to the flat image.

11. The image processing device according to claim 10, wherein
the parallax image generator generates the parallax images on which a portion on a coordinate point that is the same as a coordinate point of the figure having the transparency on the subject included in the parallax images is distinguishable from other portions of the subject.

12. The image processing device according to claim 7, wherein
the flat image generator generates the flat image having arbitrary transparency,
the image processing device further comprises a parallax image generator configured to generate the parallax images having the flat image having the arbitrary transparency that has been generated by the flat image generator at a position corresponding to the flat image based on the volume data of the subject stored in the predetermined storage device, and
the output unit outputs the parallax images generated by the parallax image generator.

13. The image processing device according to claim 12, wherein the parallax image generator generates the parallax images on which at least one of a portion of the subject at a front side relative to the flat image when seen from a user and a portion of the subject at a rear side relative to the flat image when seen from the user has arbitrary transparency.

14. The image processing device according to claim 7, further comprising a subject flat image generator configured to generate a subject flat image as a flat image of the subject that is displayed stereoscopically, wherein
the output unit outputs the subject flat image generated by the subject flat image generator.

15. The image processing device according to claim 14, further comprising a storage processor configured to store the parallax images of the subject that are displayed stereoscopically and the flat image of the subject that has been generated by the subject flat image generator in a predetermined storage unit in a corresponding manner in response to a storage instruction to store an image from a user.

16. An image processing method comprising:
receiving setting of a region of interest on parallax images of a subject that are displayed stereoscopically;
generating a flat image of a cut surface of the subject that is generated by cutting the subject along a plane corresponding to the received region of interest based on volume data of the subject stored in a predetermined storage device; and
outputting the generated flat image.

17. A medical image diagnostic device comprising:
a receiving unit configured to receive setting of a region of interest on parallax images of a subject that are displayed stereoscopically;
a flat image generator configured to generate a flat image of a cut surface of the subject that is generated by cutting the subject along a plane corresponding to the region of interest received by the receiving unit based on volume data of the subject stored in a predetermined storage device; and
an output unit configured to output the flat image generated by the flat image generator.
